(19) United States
(12) Patent Application Publication
(10) Pub. No.: US 2013/0129865 A1
(43) Pub. Date: May 23, 2013

(54) VACUUM INFUSION FOR THE INCLUSION OF A SUPPLEMENT INTO FOOD PRODUCTS

(71) Applicants: John Goold, Camperdown (AU); Dennis Forte, Wodonga (AU)

(72) Inventors: John Goold, Camperdown (AU); Dennis Forte, Wodonga (AU)

(73) Assignee: JORROCKS PTY LTD, Camperdown (AU)

(21) Appl. No.: 13/814,233

(22) PCT Filed: Aug. 3, 2011
(86) PCT No.: PCT/AU2011/000981

§ 371 Date: Feb. 4, 2013

(30) Foreign Application Priority Data
Aug. 3, 2011 (AU) 2010903463
Oct. 28, 2011 (AU) 2010904799

(51) Int. Cl. A23K 1/00

(52) U.S. Cl. CPC A23K 1/001
USPC 426/62; 426/281; 426/61; 426/648

(57) ABSTRACT

An improved method of vacuum infusion of a supplement in a porous food product comprising treating a porous food product having a majority pores of within a certain diameter size range with a supplement dispersed in a carrier wherein the supplement comprises particles the majority of which have a size range which is less than the pore diameter size range, said method performed under suitable conditions and for a suitable tone to achieve infusion of the supplement into the food product, the improvement comprising higher levels of supplement incorporation than with other supplement particle sizes.

### FIELD OF THE INVENTION

The present invention relates to a method and composition for preparing dry pet food products including a specifically formulated dietary supplement. It is particularly related to products containing inactivated probiotics, probiotics, enzymes, inactivated yeasts, botanical extracts and dairy components.

### BACKGROUND

Animal (and some human) feeds typically are supplied as pellets or pieces (“kibble”). The Pellets are typically formed from a starch and/or protein containing base ingredient, e.g. wheat or corn, mixed with a variety of other ingredients. The starch or protein containing base ingredient has a functional as well as a nutritional role in the pellet. Its functional role is to bind all other ingredients together and to provide the textural and physical (most importantly the porosity) characteristics of the product.

Binding of ingredients typically occurs because of the gelatinization of starch or the denaturation of protein. Both of these physical/chemical processes are usually carried out at elevated temperature and/or pressure. Those harsh conditions often result in the degradation of labile additives, such as probiotics and other dietary supplements. This problem has been overcome by the cold extrusion process disclosed in WO 2007/059588.

However, the cold extrusion process can be time-consuming and often forms a “bottle-neck” in many processing plants.

Thus, there is a need for an alternative process that will allow the incorporation of labile components into products prepared via other forms of the extrusion process without significant degradation of those components.

It is proposed that the installation of vacuum infusion technology as an adjunct to a standard dry pet food extrusion process will ensure that a heat-labile component may be delivered into the finished product with full functionality, whilst not causing any loss to the production capacity of the processing plant.

Liquid coatings are commonly added to the external surface of extruded products for a number of reasons including:

1) To improve product surface aesthetics (for example, the glossy coatings used on the surface of extruded rice snacks).

2) To improve product flavour (for example, the addition of flavourings greatly enhances the palatability of extruded pet food).

3) To increase the product energy density. (The addition of oils and fats to the product significantly increases the metabolizable energy of the product.)

4) To modify the product textural attributes. (The addition of a plasticizer, such as glycerol, to an extruded structure is one means of producing a “soft” texture.)

5) To allow the post-process addition of active ingredients or infusates. (Many of the most expensive functional ingredients, such as vitamins, minerals, pigments, etc are also temperature sensitive. Hence post-process addition can result in significant savings on formulation costs.)

The development of the vacuum infusion process is closely linked to the growth of the aquaculture industry. During the 1970's a number of the major feed manufacturers began to utilize extrusion cooking technology to replace the more traditional pellet milling processes. One of the major justifications for this change in processing technology was the deemed improvement in product quality and also the ability to produce feeds with an oil content in excess of 20%. The initial processing was focused predominantly on single screw extruders (S.S.E.).

Extensive research into the metabolism of various marine species (especially trout and salmon), during the early 1980's, showed that an increase in the Total Fat Content (up to at least 30%) would be beneficial. It was difficult to add this amount of oil externally on the pellets. The incorporation of this level of fat into the formulation began to stretch the limits of the extrusion technology and this lead to the use of Twin Screw Extruders and also Specialty S.S.E.

It was during this period that the Dinnissen Company (Holland) and B.P. Nutrition (now known as Nutreco) began to collaboratively develop the vacuum infusion process for the addition of significant levels of fat, post-extrusion. The major benefit of this process was that significantly higher levels of oil could be incorporated into pellets produced via standard extrusion technology.

In order to provide an understanding of how this technology works, we now describe the fundamental processes that are involved in the liquid coating of porous substrates.

The Atmospheric Coating Process

The adsorption of liquid coatings during the atmospheric coating process is primarily controlled by the action of capillary forces. The magnitude of a capillary force is determined by the radius of the capillary, Rp, and by the liquid surface tension, σ. The magnitude of the suction pressure is given by the following simple expression—Pc=2*σL*cos θw/Rp

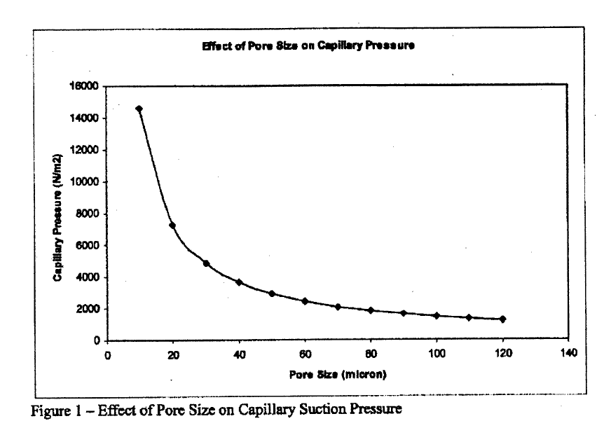

This behaviour is shown in FIG. 1 for the absorption of vegetable oil (σL=0.073 N m−1 at T=25° C.).

The data clearly indicates that the use of very fine capillaries would be beneficial. The resultant flow rate within these fine capillaries would, however, be very slow. The Fanning Equation may be used to estimate the pressure drop associated with this flow—Pf=2*f*[L/(2Rp)]*p*v2

The provision of larger pores would therefore ensure a more rapid uptake of the liquid coatings, due to the reduced pressure drop within the larger pores. The uptake of suspended infusates would also be promoted by the use of larger pores. The subsequent leakage of liquids from the pellets (a common problem for high oil content products) would, however, also be promoted by the provision of larger pores, since the capillary force will not retain the liquid within the pore.

One of the primary objectives during the manufacture of an expanded extruded product must therefore be to provide an optimal pore size distribution. The gross means of monitoring this product attribute in the manufacturing environment is via the measurement of the product bulk density.

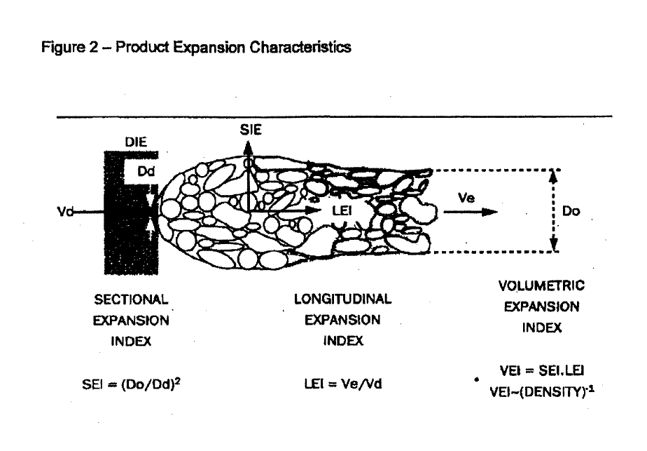

The measurement of bulk density alone is not enough, however. It is also necessary to give consideration to both the sectional expansion and longitudinal expansion. These parameters are shown schematically in FIG. 2. These parameters are commonly monitored in an indirect manner in many applications since SEI=D2/d2 (common to measure the product diameter) and LEI=f (piece length) (common to measure the cutter speed)

Changes to the magnitude of either the sectional expansion index (S.E.I.) and/or the longitudinal expansion index (L.E.I.), even at a constant bulk density or Volumetric Expansion index (V.E.I.=S.E.I.×L.E.I.) will result in significant changes to the pore morphology (i.e. the size, number and shape of the pores). These changes to the pellet internal characteristics will have an effect upon the coating characteristics of the product via an atmospheric coating process.

The magnitude of the SEI and the LEI are influenced by both the ingredient composition and via the process parameters used during the manufacture of the product.

The Vacuum Infusion Process

As a result of the limitations of both the atmospheric coating process (as outlined above) and the extrusion process (unable to handle large amounts of added oil), an alternative means of increasing the oil content of the finished product needed to be found. This scenario ultimately led to the development of the vacuum infusion process.

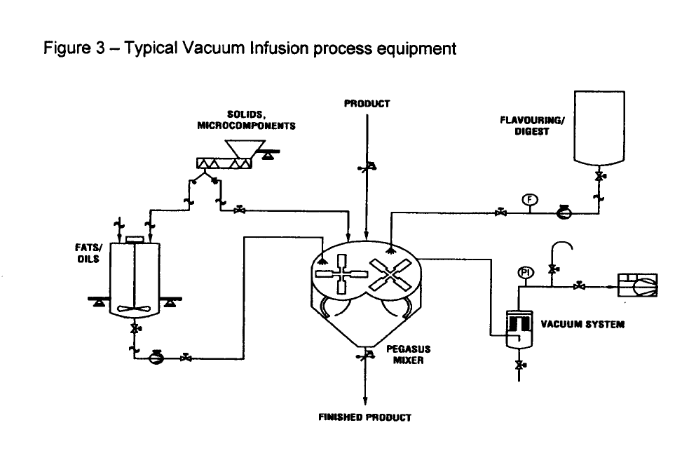

The design of a typical vacuum infusion process is presented in FIG. 3.

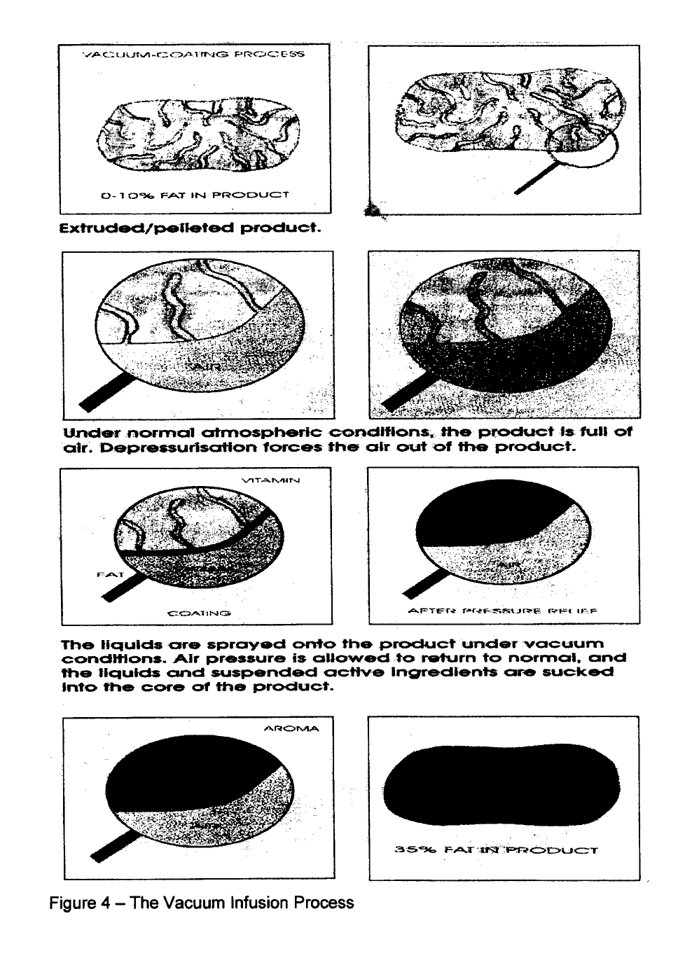

The mechanism via which the process proceeds is shown schematically in FIG. 4 and may be described via the following steps:

1) The required amount of product (typically pre-weighed in a weigh hopper) is charged into a vacuum vessel. The vessel is then sealed.

2) The vessel is then depressurized (a vacuum is drawn) to the required level (typically about 0.2 bar [abs.] or 80% Vacuum). This ensures that most of the air is removed, even from within the pores of the product.

3) The required amount of liquid coating (which may or may not contain a quantity of infusates) is then sprayed into the vessel via a series of nozzles, whilst the bed of product is being blended via mixing paddles. This ensures that all of the product surfaces become wetted.

4) The vacuum is then slowly released. The Rate of Pressure Rise, δP, is one of the most important process control points. In order for optimal coating to proceed, the external pressure must increase at a rate that is able to sustain the rate of flow of liquids into the pores. The rate of flow must also not exceed the rate of wetting of the pore inlets.

5) When the pressure within the vessel has returned to atmospheric pressure, the vessel contents may be discharged.

The above references to and descriptions of prior proposals or products are not intended to be, and are not to be construed as, statements or admissions of common general knowledge in the art.

### PREFERRED EMBODIMENTS OF THE INVENTION

In one aspect the present invention provides an improved method of vacuum infusion of a supplement into a porous food product comprising treating a porous food product having a majority pores of within a certain diameter size range with a supplement dispersed in a carrier wherein the supplement comprises particles the majority of which have a size range which is less than the pore size range, wherein said method performed under suitable conditions and for a suitable time to achieve infusion of the supplement into the food product, the improvement comprising higher levels of supplement incorporation than with other supplement particle sizes.

The term “a supplement” refers to specifically formulated dietary supplements, particularly particulate supplements, such as products containing probiotics, inactivated probiotics, yeasts, inactivated yeasts, prebiotics, enzymes, botanical extracts and/or dairy components.

The probiotics may be selected from one or more of the following group used singly or in combination and used whole or in fractions of the whole bacterial organism: Bacillus coagulants, Bacillus lichenformis, Bacillus subtilis, Bifidobacterium sp., Enterococcus faecium, Lactobacillus acidolphilus, Lactobacillus casei, Lactobacillus fermentum, Lactobacillus johnsonii, Lactobacillus paracasei, Lactobacillus reuteri, Lactobacillus ruminsis, Lactobacillus rhamnosus, Pediococcus acidilacticil.

The probiotics may be supplied in a live state, that is, capable of metabolizing nutrients and proliferating. Probiotics may also be supplied in an ‘Inactivated’ state, that is, incapable of metabolizing nutrients and proliferating. Where probiotic bacteria are supplied in the inactivated state they still maintain an identifiably approximate physical formation or structure to that manifested in the live state.

The yeasts may include any of the strains of yeasts of the species Saccharomyces cerevisiae used singly or in combination, used whole or in fractions of the whole yeast organism. The yeasts may be supplied in an active state, that is, capable of metabolizing nutrients and proliferating. Yeasts may also be supplied in a ‘inactivated’ state, that is, incapable of metabolizing nutrients and proliferating. Where yeasts are supplied in the inactivated state they still maintain the same physical formation or structure manifested in the live state.

The prebiotics may include any of the following, singly or in combination: galacto-oligosaccharide, lactulose, lactosucrose, fructo-oligosaccharide, raffinose, stachyose and malto-oligosaccharide.

The enzymes may include any of the following enzymes, singly or in combination: alpha-amylase, beta-amylase, cellulase, alpha-galactosidase, beta-glucanase, beta-glucosidase, glucoamylase, lactase, pectinase, xylanase, lipase and protease.

The term “a porous food product” means a dry or semi-moist food product which has pores or minute passages or interstices which make the product permeable to liquids. Typically this is this is dried pet food kibble or the like which has been produced by the direct expansion process after extrusion cooking or via the cold extrusion process.

The porous food may comprise a variety of grains, legumes, pulses or vegetables such as amaranth, quinoa, millet, bulgur, wild rice, cous cous, sooji, spelt, kamut, kasha, kaniwa, tapioca and the like.

The term “a majority pores of within a certain diameter size range” means substantially 80% of the pores in that size range. Generally the majority of pores in such a product are 200 to 1000 μm in diameter.

The term “dispersed in a carrier” means that the particles are kept in suspension via agitation, preferably in vegetable oil and/or tallow.

The term “particles the majority of which have a size range which is less than the pore size range” means that substantially 85% of the particles are less than the pore size range. Preferably, the particles are <250 μm and the mass average particle size is about 210 μm.

The term “performed under suitable conditions and for a suitable time to achieve infusion” means that the method is carried out under the appropriate conditions and for the appropriate time to achieve infusion. These parameters include the maximum vacuum attained (prior to the slurry being coated onto the product), the wet mixing time (during which the slurry is absorbed into the product via capillary forces) and the vacuum release rate (VRR). The accurate control of the VRR ensures that the slurry is driven into the pores.

The term “higher levels of supplement incorporation” means the processing of infusate slurries containing greater than 20% w/w particulates.

In another aspect, the invention provides an improved method of vacuum infusion of a supplement in a porous food product comprising treating a porous food product having a majority of pore sizes of less than about 1000 μm, preferably between about 250 to about 600 μm in diameter with a supplement having a particle diameter size range less than the pore size range, wherein said supplement is present in a carrier, and said method is performed under suitable conditions and for a suitable time to achieve infusion of the supplement into the food product, the improvement comprising higher levels of supplement incorporation than with other pore size and particle diameter size ranges.

In addition to the higher levels of supplement incorporation achieved with the method of the invention process times are greatly shortened. This means that the improved process of the invention allows the dried food to be produced at much lower cost. The cold extrusion process results in a reduction of the average processing rate of the extruder by approximately 50%. The use of the vacuum infusion process allows for the extruder to be operated at its rated capacity.

The preferred dietary supplement for use in the invention is Y+. Y+ is a commercial product containing probiotics, inactivated probiotics, yeasts, inactivated yeasts, probiotics and enzymes.

Preferably, the Y+ is incorporated into the finished product at a concentration of 1% w/w of the kibble.

The dietary supplement is milled (using appropriate size reduction technology) to an average particle size less than 0.5 mm or 500 μm.

The milled supplement is then blended with beef tallow, poultry tallow, fish oil or vegetable oil to form a suspension (or slurry) containing not less than 10% w/w of the supplement.

The base product (consisting of one or more extrusion cooked kibble components) is added to the vacuum coater and agitated to ensure uniform mixing. An appropriate level of vacuum is drawn on the vessel. The suspension is then added to the coater, whilst continuing the agitation in order to ensure a substantially uniform surface coating of the kibble. The vacuum is then slowly released in order to ensure the substantially uniform penetration of the supplement into the kibble. The optimal vacuum release rate can be determined experimentally.

Details of preferred vacuum infusion coating requirements are given in Table 1 and the calculation of a prediction of the wettability of kibble pellets is shown in Table 2.

Additional Considerations for Optimisation of Preferred Embodiments

Ensure that pellets have a minimal moisture content (m<20% w/w).

Ensure that pellets are uniformly dried. Case hardened pellets will retard liquid penetration due to the shrunken pores.

Ensure that the pellet core temperature is less than 50° C. This will prevent pellet moisture from boiling during the vacuum process.

Ensure that the vacuum release time is adequately slow. If liquids are drawn/driven into the capillaries more quickly than the surface wetting rate, voids will be formed within the pores.

It may be necessary to utilize a multi-stage process (drawing vacuum more than once) for some applications.

Ensure that the liquid temperature (and hence the viscosity and surface tension) is optimal.

Providing an over-pressure on the liquid supply may augment the process performance.

An external coat of solid fat may be used to seal up the pores after filling to ensure that leakage does not occur.

The shelf life of the finished product can be extended by controlling the pH level of the pellets. Preferably, the pH should be less than 7 and it is particularly preferable for the pH to be about 6.

The pellets may be prepared by using a liquid acid digest, typically obtained commercially from animal by-product renderers. Preferably, the liquid acid digest is neutralized (by a base, such as sodium hydroxide or potassium hydroxide) and then dried into a powder form.

### DETAILED DESCRIPTION OF TESTS WITH A MODEL SYSTEM

In order to gain a deeper insight into the fundamental mechanisms involved in this process a series of trials was completed using a model system.

The liquid used for the tests was vegetable oil (since it is liquid and has a low viscosity at room temperature). Jet milled Icing sugar was incorporated in order to simulate the effect of an infusate addition. (The sugar concentration was varied from 6% to 32% w/w.) The density of the slurry was related linearly to the sugar concentration via pSLURRY=0.915+0.004*[sugar](g cm-3). (It was therefore possible to determine the amount of infused sugar and/or oil via changes in the slurry density.)

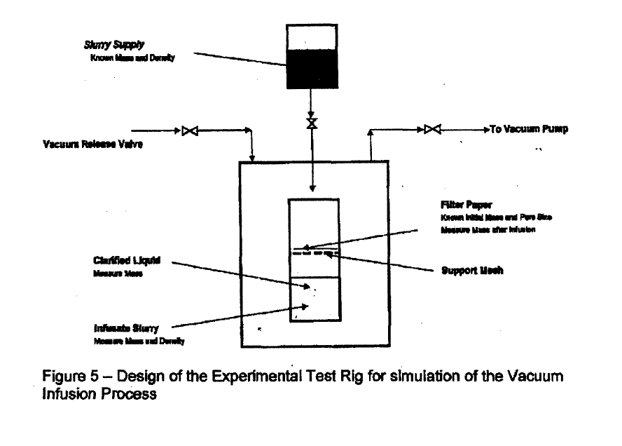

The “pore size” was controlled by using woven filter cloths made of synthetic fibres. The apparatus is shown schematically in FIG. 5.

The vacuum used for all tests was initially set at 0.2 bar and the vacuum release rate was δP=0.1 bar per 10 seconds.

The testing method used for the Investigation consisted of the following steps:

The vials (4) for each test are pre-weighed (WVi).

The filter mesh (of the required pore size) for each vial is pre-weighed (WFi) and then fitted to the vial.

The vacuum chamber is sealed and the pressure is reduced to P=0.2 bar.

A slurry is prepared, containing the required sugar concentration in vegetable oil.

The valve is opened and the chamber is allowed to fill, such that the surface of the vial is covered by˜1 cm of slurry.

The vacuum is then released at a rate of δ=0.1 per 10 seconds, and the slurry is then drained from the chamber and the vials are removed for weighing.

The following data is obtained:

WTf=Final weight of the vial, filter and collected slurry

WFf=Final weight of the filter and collected infusate

WVf=Final weight of vial and collected slurry

Vf=Volume of collected slurry

The total infused weight (oil and sugar) is determined from the average of the four individual results at each slurry concentration, via W=WVf−(WVi+WFi)

The density of the collected slurry is given by pSLURRY=(WVf−WVi)/Vf

The total infusate added is given by M={Vf*(pSLURRY−0.915)/0.0004}+(WFf−Wfi)

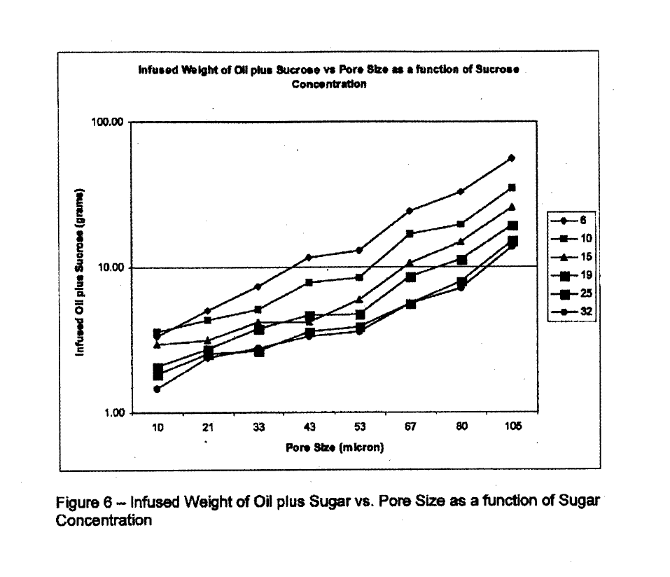

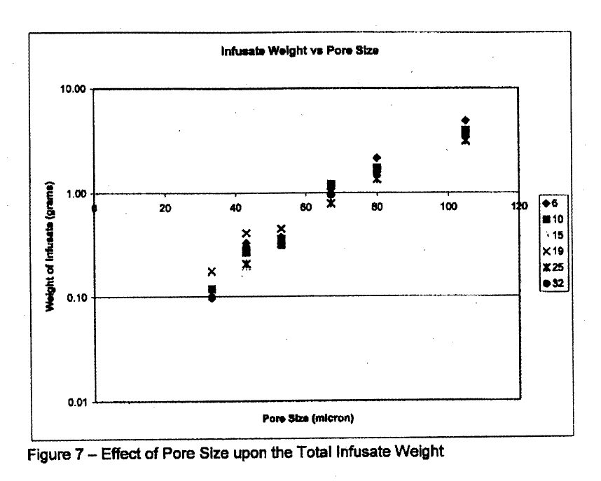

The results obtained from the tests are best presented in a graphical form as shown in FIG. 6.

The data clearly shows that both the pore size (most significant) and also the slurry concentration have an impact upon the total infused weight of the finished product. The result may be modeled via W=f[Rp-0.0005, c-0.7, exp(Rp)](r2=0.87).

Inspection of the slurry collected within the vials showed that two distinct layers existed. Initially the material passing through the cloth consisted of true slurry. As the test proceeded, however, the material became clearer. The cloths were acting as a filter and the coarser particles were being retained. This is given further validation when one considers the infusate weight alone.

These data may be readily modeled via M=f[Rp3](r2=0.96).

The data obtained from these experiments clearly shows that the provision of an optimal pore size distribution is indeed critical to the adequate operation of a vacuum infusion process. The data also indicates that the amount of infusate that may be added is independent of the slurry concentration.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

“Comprises/comprising” when used in this specification is taken to specify the presence of stated features, integers, steps or components but does not preclude the presence or addition of one or more other features, integers, steps, components or groups thereof.

TABLE 1
Vacuum Infusion Coating Requirements
Product Requirements

| Finished Product Required, F | 1000.0 kg | |
|---|---|---|
| Additive Inclusion Level, [a] | 1.1% w/w of Finished Product | 11.0 kg |
| Slurry Coating Level, C | 7.5% w/w of Finished Product | 75.0 kg |
| Base Product Required, P | 925.0 kg | |
| Brown Kibble | 90.0% | 832.5 kg |
| White Kibble | 10.0% | 92.5 kg |

Coating Slurry Make up

| | | |
|---|---|---|
| Oil, O | 64.0 kg | |
| Supplement, S | 11.0 kg | 17.2% |
| | | of Slurry |

TABLE 2
Prediction of the Wettability of Pellets
Washburn Equation
t = 8 * u * z²/(s * R_{ρ})

| | | | |
|---|---|---|---|
| Fluid Viscosity, u | 0.06 | Ns m⁻² | |
| Fluid Surface Tension, s | 0.072 | N m⁻¹ | |
| Pellet Diameter, d | 8.0 | mm | 0.008 m |
| Pore Length, z | 4.0 | mm | 0.004 m |
| Pore Radius, R_{ρ} | 50.0 | micron | 0.00005 m |
| | | t = 2.13 s | |

Modified Washburn Equation
t = h_{κ} * a * (1 − E) * u * z²/[E * s * cos a]

| | | | |
|---|---|---|---|
| h_{κ} | 0.005 | | |
| a | 4000 | m² m⁻³ | |
| E | 0.3 | — | 0.2 < E < 0.5 |
| cos a | 1 | — | |
| | | t = 3.73 s | |

1. A method of vacuum infusion of a supplement in a porous food product comprising treating a porous food product having a majority of pore sizes of less than about 1000 μm, in diameter with a supplement having a particle diameter size range less than the pore size range, wherein said supplement is present in a carrier, and said method is performed under suitable conditions and for a suitable time to achieve infusion of the supplement into the food product, the improvement comprising higher levels of supplement incorporation than with other pore size and particle diameter size ranges

2. The method of claim 1 wherein the majority of pore sizes are between about 250 to about 600 μm in diameter.

3. A method of vacuum infusion of a supplement in a porous food product comprising treating a porous food product having a majority pores of within a certain diameter size range with a supplement dispersed in a carrier wherein the supplement comprises particles the majority of which have a size range which is less than the pore diameter size range, said method performed under suitable conditions and for a suitable time to achieve infusion of the supplement into the food product, the improvement comprising higher levels of supplement incorporation than with other supplement particle sizes.

4. The method of claim 3 wherein the particle size is around 500 μm.

5. The method of claim 1 wherein the supplement comprises probiotics, inactivated probiotics, yeasts, inactivated yeasts, probiotics and/or enzymes.

6. The method of claim 5 wherein the supplement is Y+.

7. A porous food product produced by the method of claim 1.

8. The porous food product of claim 7 in which the supplement is incorporated at a concentration of at least 1.1% w/w of finished food product.
